(19) United States
(12) Patent Application Publication
(10) Pub. No.: US 2024/0419519 A1
(43) Pub. Date: Dec. 19, 2024

(54) METHOD AND APPARATUS FOR DATA PROCESSING, AND STORAGE MEDIUM

(71) Applicant: BOE Technology Group Co., Ltd., Beijing (CN)

(72) Inventors: Jinxiao WEN, Beijing (CN); Ning ZHANG, Beijing (CN)

(21) Appl. No.: 18/704,909

(22) PCT Filed: Jul. 7, 2023
(86) PCT No.: PCT/CN2023/106367

§ 371 Date: Apr. 25, 2024

(30) Foreign Application Priority Data
Jul. 27, 2022 (CN) 202210891887.2

(51) Int. Cl. G06F 9/54

(52) U.S. Cl. CPC G06F 9/546; G06F 2209/547; G06F 2209/548

(57) ABSTRACT

A method and apparatus for data processing, and a storage medium. The data processing method comprises: receiving data from a calling party, and generating a first message according to the data and sending the first message to a first message queue; monitoring the first message queue, once it is monitored that the first message is present in the first message queue, obtaining the data according to the first message in the first message queue, performing preset processing according to the data, generating at least one processing result, and generating a result message according to the processing result and sending the result message to a result message queue corresponding to the processing result; and monitoring the result message queue, once it is monitored that the result message is present in the result message queue, obtaining the processing result according to the result message of the result message queue, and sending the processing result to the calling party.

### CROSS-REFERENCE TO RELATED APPLICATIONS

The present application is a U.S. National Phase Entry of International Application No. PCT/CN2023/106367 having an international filing date of Jul. 7, 2023, which claims priority to Chinese Patent Application No. 202210891887.2, filed to the CNIPA on Jul. 27, 2022 and entitled “Method and Apparatus for Data Processing, and Storage Medium”, contents of the above-identified applications should be regarded as being incorporated herein by reference.

### TECHNICAL FIELD

The present disclosure relates to data processing technologies, in particular to a data processing method and apparatus, and a storage medium.

### BACKGROUND

During making a production plan in a factory, in combination with a strategic objective, a capacity bottleneck, a product priority, a material inventory, and other factors, a plurality of versions of the plan will be produced, and repeated iterative adjustments are made to the production plan at any time, according to changes in a situation.

### SUMMARY

The following is a summary of subject matters described herein in detail. The summary is not intended to limit the protection scope of claims.

A data processing method is provided in an embodiment of the present disclosure, which includes: receiving data from a caller, generating a first message according to the data, and sending the first message to a first message queue; monitoring the first message queue, acquiring the data according to the first message in the first message queue after monitoring the first message existing in the first message queue, performing preset processing according to the data, generating at least one processing result, generating a result message according to the processing result and sending the result message to a result message queue corresponding to the processing result; monitoring the result message queue, acquiring the processing result according to the result message of the result message queue after monitoring the result message existing in the result message queue, and sending the processing result to the caller.

In an exemplary embodiment, one processing result corresponds to one result message queue.

In an exemplary embodiment, the first message includes a storage path of the data, and the result message includes a storage path of the processing result.

In an exemplary embodiment, the generating at least one processing result includes: generating summary result data and detailed result data, wherein a data volume of the summary result data is smaller than a data volume of the detailed result data; the result message queue includes a second message queue and a third message queue; the generating the result message according to the processing result and sending the result message to the result message queue corresponding to the processing result, includes: generating a second message to the second message queue according to the summary result data, and generating a third message to the third message queue according to the detailed result data; the monitoring the result message queue, acquiring the processing result according to the result message of the result message queue after monitoring the result message existing in the result message queue, and sending the processing result to the caller, includes: monitoring the second message queue, acquiring the summary result data according to the second message in the second message queue after monitoring the second message existing in the second message queue, and sending the summary result data to the caller; and monitoring the third message queue, acquiring the detailed result data according to the third message in the third message queue after monitoring the third message existing in the third message queue, and sending the detailed result data to the caller.

In an exemplary embodiment, the data includes product demand information and related material information.

The summary result data includes at least one of following: a complete set quantity of products, a gap quantity between a required quantity of the products and the complete set quantity; and the detailed result data includes a possible material formula of the products.

In an exemplary embodiment, the receiving the data from the caller includes: receiving, from the caller, data packages obtained by splitting; after receiving the data packages of a same batch of data completely, merging the data packages of the batch of data to generate a data file, wherein one batch of data is data on which preset processing is performed once; the generating the first message according to the data and sending the first message to the first message queue, includes: sending a storage path of a data file of a current batch of data to the first message queue.

In an exemplary embodiment, the receiving the data packages from the caller and receiving the data packages of the same batch of data completely, includes: acquiring batch information and a total package quantity carried in the data packages, counting received data packages with same and non-repeated batch information, and determining that the data packages of the same batch of data have been received when a count value reaches the total package quantity.

In an exemplary embodiment, the sending the processing result to the caller, includes: splitting a same processing result of a same batch of data into data packages according to a preset size, and sending the data packages obtained by splitting to the caller.

In an exemplary embodiment, the processing result includes summary result data and detailed result data, and the method further includes: when sending the data packages obtained by splitting to the caller, carrying data type indication information to indicate that the data packages are the summary result data or the detailed result data.

In an exemplary embodiment, the acquiring the data according to the first message in the first message queue, performing preset processing according to the data, and generating at least one processing result, includes: acquiring the data from a plurality of first messages in the first message queue using a plurality of processes, respectively, performing preset processing according to the data, and generating at least one processing result.

In an exemplary embodiment, the receiving data from the caller, generating the first message according to the data and sending the first message to the first message queue, includes: receiving, by the interface application service, the data from the caller, generating the first message according to the data and sending the first message to a message middleware; sending, by the message middleware, the first message to the first message queue; the monitoring the first message queue, acquiring the data according to the first message in the first message queue after monitoring the first message existing in the first message queue, performing preset processing according to the data, generating at least one processing result, generating the result message according to the processing result and sending the result message to the result message queue corresponding to the processing result, includes: monitoring, by an algorithm service, the first message queue, acquiring the data according to the first message in the first message queue after monitoring the first message existing in the first message queue, performing preset processing according to the data, generating at least one processing result, generating the result message according to the processing result and sending the result message to the message middleware; sending, by the message middleware, the result message to the result message queue corresponding to the processing result; the monitoring the result message queue, acquiring the processing result according to the result message of the result message queue after monitoring the result message existing in the result message queue, and sending the processing result to the caller, includes: monitoring, by the interface application service, the result message queue, acquiring the processing result according to the result message of the result message queue after monitoring the result message existing in the result message queue, and sending the processing result to the caller.

A computer device is provided in an embodiment of the present disclosure, including a processor and a memory storing a computer program runnable on the processor, wherein when the processor executes the program, acts of the data processing method according to any one of the above-mentioned embodiments are implemented.

A computer readable storage medium is provided in an embodiment of the present disclosure, in which program instructions are stored, and when the program instructions are executed, the data processing method according to any one of the above-mentioned embodiments is implemented.

A data processing apparatus is provided in an embodiment of the present disclosure, which includes an interface application service, a message middleware, and an algorithm service, wherein the interface application service is configured to receive data from a caller, generate a first message according to the data and send the first message to the message middleware, monitor a result message queue, acquire a processing result according to a result message of the result message queue after monitoring the result message existing in the result message queue, and send the processing result to the caller; the algorithm service is configured to monitor the first message queue, acquire the data according to the first message in the first message queue after monitoring the first message existing in the first message queue, perform preset processing according to the data, generate at least one processing result, generate a result message according to the processing result and send the result message to the message middleware; and the message middleware is configured to receive the first message and send the first message to the first message queue, receive the result message and send the result message to a corresponding result message queue.

Other aspects may be comprehended after drawings and detailed description are read and understood.

### BRIEF DESCRIPTION OF DRAWINGS

Accompany drawings are used for providing further understanding of technical solutions of the present disclosure, and constitute a part of the description. The accompany drawings, together with embodiments of the present disclosure, are used for explaining the technical solutions of the present disclosure, and do not constitute limitations on the technical solutions of the present disclosure.

FIG. 1 is a flowchart of a data processing method according to an embodiment of the present disclosure.

FIG. 2 is a schematic diagram of a data processing apparatus according to an embodiment of the present disclosure.

FIG. 3 is a schematic diagram of a message middleware according to an embodiment of the present disclosure.

FIG. 4 is a flowchart of a data processing method according to an exemplary embodiment.

FIG. 5 is a block diagram of a data processing apparatus according to an exemplary in embodiment.

### DETAILED DESCRIPTION

Multiple embodiments are described in the present disclosure. However, the description is exemplary and unrestrictive. Moreover, it is apparent to those of ordinary skills in the art that there may be more embodiments and implementation solutions in the scope of the embodiments described in the present disclosure. Although many possible combinations of features are shown in the accompanying drawings and discussed in specific implementation modes, many other combinations of the disclosed features are also possible. Unless expressly limited, any feature or element of any embodiment may be used in combination with, or may replace, any other feature or element in any other embodiment.

The present disclosure includes and conceives combinations with features and elements known to those of ordinary skills in the art. The embodiments, features, and elements that have been disclosed in the present disclosure may also be combined with any conventional feature or element to form unique inventive solutions defined in the claims. Any feature or element of any embodiment may also be combined with a feature or an element from another inventive solution to form another unique inventive solution defined in the claims. Therefore, it should be understood that any of features shown and/or discussed in the present disclosure may be implemented alone or in any suitable combination. Therefore, the embodiments are not limited except limitations by the appended claims and equivalents thereof. In addition, various modifications and variations may be made within the protection scope of the appended claims.

Moreover, when describing representative embodiments, the specification may have presented a method and/or a process as a particular sequence of acts. However, to an extent that the method or the process does not depend on the specific order of the acts described herein, the method or the process should not be limited to the acts with the specific order. Those of ordinary skills in the art will understand that other order s of acts may also be possible. Therefore, the specific order of the acts illustrated in the specification should not be interpreted as a limitation on claims. Moreover, claims directed to the method and/or process should not be limited to performing their acts in a described order, and those skilled in the art may readily understand that these orders may be varied and still remain within the spirit and scope of the embodiments of the present disclosure.

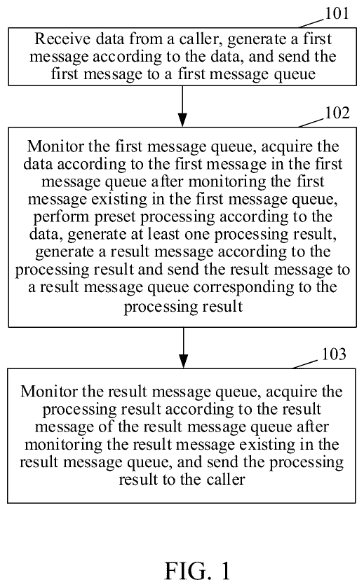

FIG. 1 is a flowchart of a data processing method according to an embodiment of the present disclosure. As shown in FIG. 1, a data processing method is provided in an embodiment of the present disclosure, including acts 101 to 103.

In the act 101, data is received from a caller, a first message is generated according to the data, and the first message is sent to a first message queue.

In the act 102, the first message queue is monitored, the data is acquired according to the first message in the first message queue after monitoring the first message exists in the first message queue, preset processing is performed according to the data, at least one processing result is generated, a result message is generated according to the processing result, and the result message is sent to a result message queue corresponding to the processing result.

In the act 103, the result message queue is monitored, the processing result is acquired according to the result message of the result message queue after monitoring the result message existing in the result message queue, and the processing result is sent to the caller.

According to the data processing method provided in the embodiment of the present disclosure, different message queues are used for achieving data reception, processing, and returning a processing result, which may achieve asynchronous processing and reduce processing time, and may achieve decoupling between data reception, processing, and result returning. In addition, a message to be processed is buffered in a message queue, which may limit flow and cut a peak.

In an exemplary embodiment, the caller may be a control party of a service, or may be a third party. When the caller is the third party, a visual user interface may be provided, which is convenient for operation and provides a visual result to improve user experience.

In an exemplary embodiment, a processing result may correspond to a result message queue. However, the embodiments of the present disclosure are not limited thereto, and one processing result may correspond to a plurality of result message queues. When one processing result corresponds to one result message queue, and a quantity of message queues to be monitored is small, system resource consumption may be reduced.

In an exemplary embodiment, the first message queue may include one or more message queues. When there is only one message queue in the first message queue, only one message queue may be monitored to reduce system resource consumption.

In an exemplary embodiment, different types of processing results may correspond to different result message queues.

In an exemplary embodiment, the first message may include a storage path of the data, and the result message may include a storage path of the processing result. In the implementation, the storage path is sent to the message queue, which may reduce bearing pressure of the message queue and avoid overload and collapse of the message queue, compared with sending data directly.

In an exemplary embodiment, generating at least one processing result may include generating summary result data and detailed result data, wherein a data volume of the summary result data is smaller than a data volume of the detailed result data; the result message queue includes a second message queue and a third message queue; generating the result message according to the processing result and sending the result message to the result message queue corresponding to the processing result includes: generating a second message to the second message queue according to the summary result data, and generating a third message to the third message queue according to the detailed result data; monitoring the result message queue, acquiring the processing result according to the result message of the result message queue after monitoring the result message exists in the result message queue, and sending the processing result to the caller, may include: monitoring the second message queue, acquiring the summary result data according to the second message in the second message queue after monitoring the second message exists in the second message queue, and sending the summary result data to the caller; and monitoring the third message queue, acquiring the detailed result data according to the third message in the third message queue after monitoring the third message exists in the third message queue, and sending the detailed result data to the caller.

According to a solution provided in the embodiment, generating summary result data with small data volume when generating the processing result may occupy less transmission resources, reduce transmission time, feed the result back to the caller in time, and enhance real-time performance.

In an exemplary embodiment, the data may include product demand information and related material information.

The summary result data may include at least one of following: a complete set quantity of products, a gap quantity between a required quantity of the products and the complete set quantity; and the detailed result data includes a possible material formula of the products.

The solution provided in the implementation may be applied to complete set calculation of products. By feeding back the summary result data, the complete set quantity may be fed back in time, which is convenient for formulation and adjustment of a generation plan in time.

In an exemplary embodiment, receiving the data from the caller may include: receiving, from the caller, data packages obtained by splitting; after receiving data packages of a same batch of data completely, merging the data packages of the batch of data to generate a data file, wherein one batch of data is data on which the preset processing may be performed once; and generating the first message according to the data and sending the first message to the first message queue, may include: sending a storage path of a data file of a current batch of data to the first message queue.

In the embodiment, by receiving the data packages obtained by splitting, pressure on a server may be reduced, and server processing failure caused by a large number of one-time transmissions may be avoided.

In an exemplary embodiment, receiving the data packages from the caller and receiving data packages of the same batch of data completely, may include: acquiring batch information and a total package quantity carried in the data packages, counting received data packages with same and non-repeated batch information, and determining that the data packages of the same batch of data have been received when a count value reaches the total package quantity. In this embodiment, since the data packages may be sent out of order, integrity verification of the batch of data is achieved by counting the data packages.

In an exemplary embodiment, sending the processing result to the caller may include: splitting a same processing result of a same batch of data into data packages according to a preset size, and sending the data packages obtained by splitting to the caller. In the embodiment, result data is sent by means of package splitting, which may reduce the pressure on the server and avoid server processing failure caused by a large number of one-time transmissions.

In an exemplary embodiment, the processing result may include summary result data and detailed result data, and the method may further include that, when sending the data packages obtained by splitting to the caller, carrying data type indication information to indicate that the data packages are the summary result data or the detailed result data. According to the solution provided in the embodiment, a type of returned result data is prompted.

In an exemplary embodiment, acquiring the data according to the first message in the first message queue, performing preset processing according to the data, and generating at least one processing result, may include: acquiring the data from a plurality of first messages in the first message queue respectively by using a plurality of processes, performing preset processing according to the data, and generating at least one processing result. In the embodiment, by processing the first messages through the plurality of processes, a processing efficiency may be improved, and accumulation and calculation response delay caused by existence of the plurality of first messages may be avoided.

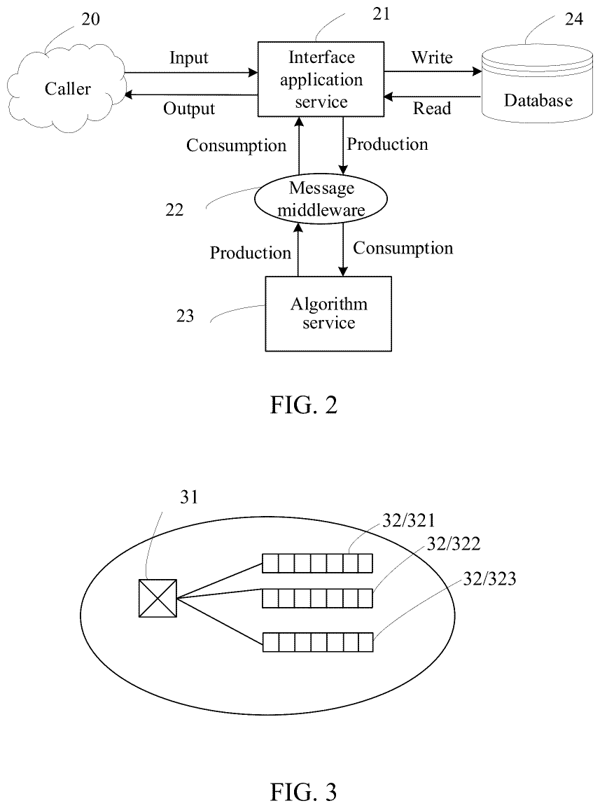

FIG. 2 is a schematic diagram of a data processing apparatus according to an exemplary embodiment. As shown in FIG. 2, the data processing apparatus provided in the embodiment may include an interface application service 21, a message middleware 22, and an algorithm service 23.

The interface application service 21 is configured to receive data from a caller 20, generate a first message according to the data and send the first message to the message middleware 22, monitor a result message queue, acquire a processing result according to a result message of the result message queue after monitoring the result message exists in the result message queue, and send the processing result to the caller 20.

The algorithm service 23 is configured to monitor the first message queue, acquire the data according to the first message in the first message queue after monitoring the first message exists in the first message queue, perform preset processing according to the data, generate at least one processing result, generate a result message according to the processing result and send the result message to the message middleware 22.

The message middleware 22 is configured to receive the first message and send the first message to the first message queue, receive the result message and send the result message to a corresponding result message queue.

In an exemplary embodiment, the data processing apparatus may further include a database 24. The interface application service 21 interacts with the database 24 to achieve integrity verification of a batch of data. Implementation of the interaction will be described in detail in subsequent examples.

In an exemplary embodiment, the interface application service 21 may be an Application Programming Interface (API) interface application service. The database 24 may be implemented based on, but is not limited to, MySQL, or may be implemented based on another type of database such as Structured Query Language (SQL). A message queue may be, but is not limited to, a RabbitMQ message queue, or may be a RocketMQ message queue, an ActiveMQ message queue, a Kafka message queue, or the like.

In an exemplary embodiment, the interface application service 21, the message middleware 22, the algorithm service 23, the database 24 and the like may be deployed in isolation with a docker container. The docker container is an open source application container engine. Developers may package an application and a dependency package into a portable container in a unified way, and then publish them to any server installed with a docker engine. Each container has its own isolated user space. When establishing a docker container of the interface application service 21, the message middleware 22, the algorithm service 23, or the database 24, a suitable image may be downloaded from an image repository, and a corresponding docker container may be generated by establishing an application instance of the image. In an exemplary embodiment, data sharing among the interface application service 21, the message middleware 22, the database 23, and algorithm service 24 and the like may be achieved by mapping to a same local path.

FIG. 3 is a schematic diagram of a message middleware according to an exemplary embodiment. As shown in FIG. 3, a message middleware 22 may include one or more message exchangers 31 and at least one message queue 32. Only one message exchanger 31 is shown in FIG. 3, but the embodiment of the present disclosure is not limited thereto, and there may be a plurality of message exchangers 31 connected with a plurality of message queues 32, respectively. The plurality of message exchangers 31 may form multiple stages. That is, messages are delivered to the message queues after passing through the message exchangers of multiple stages. After receiving a message, a message exchanger 31 delivers the message to a post-stage message exchanger 31 or a corresponding message queue 32, according to a routing key routing_key carried in the message. When the message is delivered to the post-stage message exchanger 31, the post-stage message exchanger 31 continues to deliver until the message is delivered to a corresponding message queue. In the embodiment, the message middleware 22 may include three message queues: a first message queue 321, a second message queue 322, and a third message queue 323, which receive a first message sent by an interface application service 21, a second message sent by an algorithm service 23, and a third message, respectively.

Implementation of a technical solution of the embodiment of the present disclosure is described below through one example.

In the implementation, a caller 20 splits and sends a same batch of data. That is, the same batch of data is split into a plurality of data packages and then sent. The interface application service 21 receives the data packages. When the data packages of the same batch of data are received, the interface application service 21 merges the data packages of the batch of data, stores them as a data file, generates a first message including a storage path of the data file, and sends the first message to the message middleware 22, the message middleware 22 sends the first message to a first message queue. The algorithm service 23 monitors the first message queue, acquires a first message when the algorithm service 23 monitors that the first message exists in the first message queue, acquires data in the data file according to the storage path of the data file carried in the first message, performs preset calculation according to the data, generates summary result data and detailed result data, stores the summary result data as a summary result data file, stores the detailed result data as a detailed result data file, generates a second message including a storage path of the summary result data file, generates a third message including a storage path of the detailed result data file, and sends the second message and the third message to the message middleware 22. The message middleware 22 sends the second message to the second message queue 322 and sends the third message to the third message queue 323. The interface application service 21 monitors the second message queue 322 and the third message queue 323. The interface application service 21 acquires the second message when the interface application service 21 monitors that the second message exists in the second message queue, the interface application service 21 acquires the summary result data according to the storage path of the summary result data file carried in the second message, acquires the detailed result data according to the storage path of the detailed result data file, splits the summary result data into data packages and sends them to the caller 20, and splits the detailed result data into data packages and sends them to the caller 20.

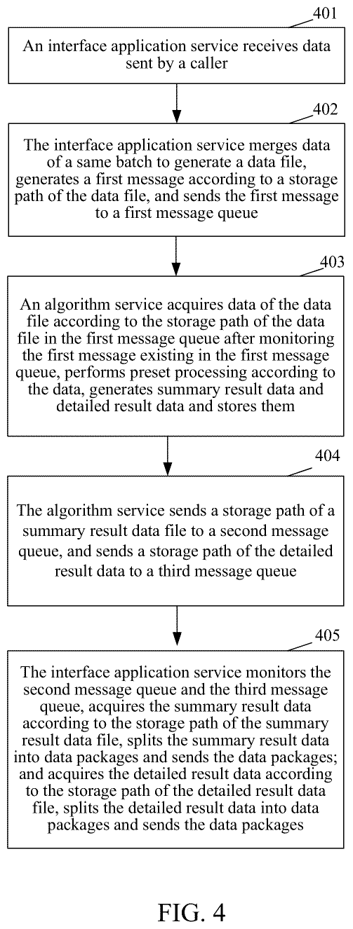

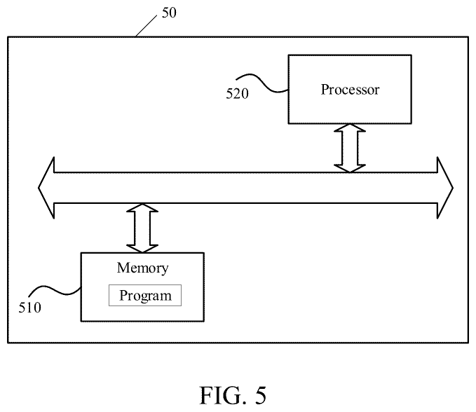

FIG. 4 is a schematic diagram of a data processing method according to an exemplary embodiment. As shown in FIG. 4, the data processing method according to the embodiment includes acts 401 to 405.

In the act 401, an interface application service 21 receives data sent by a caller 20.

The data may be split data. That is, one batch of data is split into a plurality of data packages and then sent, and each data package may include a plurality of pieces of data. For example, one row of data in Table 3 may be taken as one piece of data, but the embodiment of the present disclosure is not limited thereto, and one piece of data may include a plurality of rows of data. Among them, one batch of data refers to complete input data that may be used for algorithm calculation of one time.

In an exemplary embodiment, the interface application service 21 may communicate with the caller 20 through a Hyper Text Transfer Protocol (HTTP), but the embodiment of the present disclosure is not limited thereto, and the interface application service 21 may communicate with the caller 20 through another protocol.

In an exemplary embodiment, a data package may carry data batch information to which the data package belongs. For example, the data package may carry a batch number, a total package quantity, and a current data package number, as shown in Table 1. Among them, batchid represents the a batch number of a batch of complete data, which is a unique identifier of the batch of data, and batchid of different batches of data are different; total_split_package represents a total quantity of packages in which the batch of data is split; and currentpackage represents a number of a current data package. The batch number may be a character string, but is not limited thereto, or may be a number.

TABLE 1
Schematic table of information carried in data package

| batchid | Batch number (unique ID) |
|---|---|
| total_split_package | Total package quantity |
| currentpackage | Current data package number |

In an exemplary embodiment, when the interface application service 21 receives data packages, since the data packages may arrive out of order, integrity verification may be performed. That is, whether all data packages of one batch of data have been received is verified. One verification method is as follows: a quantity of received data packages belonging to a same batch of data may be recorded; when the quantity of received data packages of the same batch of data is the same as a total package quantity of the batch of data, it means that all data packages of the batch of data have been completely received.

In an exemplary embodiment, the interface application service 21 may achieve integrity verification by interacting with a database 24. Two data tables, _api_package and _api_package_item, may be created in the database 24. The table _api_package is used for storing information related to the batch of data, and the table _api_package_item is used for storing information of data packages in a batch. Fields of the table _api_package and the table _api_package_item are shown in Table 2.

TABLE 2
_api_package and _api_package_item data tables

| Data table | Field name | Notes |
|---|---|---|
| _api_package | package_id | Auto-incremented id. Whenever one batch |
| | | of data is received, a count is increased once. |
| | | That is, each batch of data corresponds to one |
| | | package_id |
| | batch_id | Batch number (unique ID) |
| | total_split_package | Total package quantity |
| | if_completed | Whether it is complete, that is, whether all |
| | | data packages of a batch of data indicated by |
| | | batch_id are received completely |
| | if_send | Whether it is successfully sent to a message |
| | | queue, that is, indicating whether a storage |
| | | path of a data file of a batch of data indicated |
| | | by batch_id is sent to a first message queue |
| | receive_start_at | Start time of receiving data |
| | receive_end_at | End time of receiving data |
| | request_data | A storage path of a data file of a batch of |
| | | data indicated by batch_id |
| | . . . | Other data information |
| _api_package_item | item_id | Auto-incremented id. Whenever a data |
| | | package is received, a count is increased once |
| | package_id | Foreign key, corresponding to a field |
| | | package_id in _api_packag |
| | batch_id | Batch number (unique ID) |
| | current_package | Current data package number |
| | received_data | Storage path of data of data package |
| | created_at | Time to start receiving data packages |
| | . . . | Other data information |

When receiving one data package, the interface application service 21 determines whether batchid of the data package exists in the table _api_package. If not, it means that the data package is a first data package of a batch of data, and a record is inserted in the table _api_package. In this record, a value of a field package_id is increased by one count, a field batch_id is recorded as batchid of a currently received data package, and total_split_package refers to a total quantity of packages carried in the currently received data package; an initial state data integrity field is set to if_completed=0, a field indicating whether data information is sent to a message queue is set to if_send=0, and start time of a received batch of data is recorded in a field receive_start_at; and a record of the data package is inserted in the table _api_package_item. In this record, item_id is increased by one count, a value of package_id is consistent with a value of the field package_id in the table _api_package, the field batch_id records batchid of the data package, and a field current_package records a current data package number, a field received_data records a storage path of data of a current data package, and a field created_at records time of starting receiving a data package.

In a process of receiving the data package, a first counter cnt1 is used for counting data packages of the batch of data, and a count value of cnt1=1 is recorded when a first data package is received. When a subsequent data package of the batch of data arrives, if batchid carried in the data package already exists in the table _api_package, no new record is added in the table _api_package but a new record is added in the table _api_package_item, so as to record relevant information of a newly received data package, and the received data package of the batch are counted cnt1+=1.

When some data packages are the same, the same data package which is received later is discarded to ensure consistency and integrity of data.

When the count value of the first counter cnt1=total_split_package, it indicates that the batch of data has arrived locally completely and has been successfully received. At this time, a field if_completed in a record of the batch of data in the table _api_package is modified, and if_completed=1 is set to indicate that the batch of data is completely received. End time of receiving the batch of data is recorded through a field receive_end_at, and the count value of the first counter cnt1 is reset.

Fields in Table 2 are examples only. In other exemplary embodiments, the fields may be increased or decreased. For example, only batch information of a received data package may be recorded, and a quantity of data packages of a same batch may be counted.

In the act 402, the interface application service 21 merges data of a same batch to generate a data file, generates a first message according to a storage path of the data file, and sends the first message to a first message queue 321.

After receiving the data of the same batch completely, the interface application service 21 merges data of all data packages of the batch, writes merged complete data into a local file, generates the data file of the batch of data, and sends the first message to the first message queue 321, wherein the first message carries the storage path of the data file. The first message may further carry a message exchanger name, a routing key, and data identifier package_id information (i.e., package_id in Table 2), wherein the routing key is a routing rule, and the message exchanger sends a message to a corresponding message queue according to the routing key. In the embodiment, the routing key in the first message indicates that the first message is sent to the first message queue 321. The first message is sent to a message exchanger indicated by the message exchanger name, and the message exchanger delivers the first message to the first message queue 321 according to the routing key carried in the first message. Subsequently, the algorithm service 23 reads the data file according to the storage path of the data file for calculation. The interface application service 21 updates the field if_send=1 of a record corresponding to the batch of data in a data table _api_package, indicating that the storage path of the data file generated according to the current batch of data has been successfully sent to the first message queue 321; and a field request_data of a record corresponding to the batch of data is set to record the storage path of the data file of the batch of data. The interface application service 21 may generate a log file from data obtained by merging data packages of one batch of data and store the log file locally.

In the above-mentioned embodiments, a batch of data is identified using package_id. When batchid is a character and package_id is a number, package_id is used for identifying the batch of data, which occupies less storage resources than using batchid, and may save resources. In addition, when package_id is a number, a data table index may be established to improve query efficiency when querying a batch of data. However, embodiments of the present disclosure are not limited thereto, and the batch of data may be identified directly using batchid without using package_id. That is, there may be no package_id in Table 2 above and subsequent Table 7.

In an embodiment of the present disclosure, the first message in the first message queue 321 may be path information of the data file, which is a lightweight message communication mechanism. Compared with directly putting the data file in the message queue, a bearing pressure of the first message queue may be reduced, and overload and collapse of the first message queue may be avoided.

In another exemplary embodiment, the data file may be sent directly to the first message queue 321 when a data volume of the data file is smaller than or equal to a preset threshold. The preset threshold value may be set as required.

In an exemplary embodiment, the data may be product material data, and may include product demand information and related material information. For different factories, types and quantities of products may be different, materials used may also be different, and a size of data of one batch is not constant. In addition, data of one batch may be product material data in different time ranges, for example, it may be monthly product material data, or may be daily product material data, amounts of data are quite different. Among them, some batches of data have relatively a large amount of data, and sending data of a data file directly to a message queue may lead to overload and collapse of the message queue. In the embodiment of the present disclosure, a storage path of the data file is sent to the message queue, which occupies less resource and may avoid collapse of the message queue.

In the act 403, the algorithm service 23 monitors the first message queue 321, acquires the first message in the first message queue 321 after monitoring the first message exists in the first message queue 321, acquires data of the data file according to the storage path of the data file carried in the first message, performs preset processing according to the data, generates summary result data and detailed result data and stores them.

The preset processing may be computed based on a preset algorithm, or other data processing may be performed, etc. The preset processing may be set as required.

The algorithm service 23 may establish communication with the message middleware 22, and a connection between the algorithm service 23 and the message middleware 22 is maintained through a heartbeat mechanism. The algorithm service 23 may subscribe to a message of the first message queue 321. After the message arrives at the first message queue 321, the algorithm service 23 is triggered to acquire the message from the first message queue 321.

In the embodiment, the algorithm service 23 may be a complete set algorithm service, and the data is processed through the complete set algorithm. The complete set algorithm refers to calculating a quantity of products that may be produced according to products, required materials, a product demand, a material inventory, etc. For a factory with a plurality of styles of products to be produced, each style of product needs different amounts of materials, and materials may be classified into mandatory materials and alternative materials with different priorities. Based on existing quantitative materials, a production plan is obtained by overall calculation. That is, a production quantity of products is determined under given product demand and material inventory. For example, it may be a production plan that maximizes production capacity or income.

In an exemplary implementation, the data may be as shown in Table 3, and one batch of data may include a plurality of pieces of data, wherein each piece of data may include, but is not limited to, a product number, a material number, an alternative group mark, a material usage priority, unit consumption, a material inventory, a product demand, and the like. Among them, for a same product model, materials with a same alternative group mark are alternative materials, and the unit consumption means that several corresponding materials need to be consumed to produce a product.

TABLE 3
Data received from caller

| | | Alter- | | | | |
|---|---|---|---|---|---|---|
| | | native | Material | Unit | | |
| Product | Material | group | usage | consump- | Material | Product |
| number | number | mark | priority | tion | inventory | demand |
| PRO-1 | mat-1 | | 0 | 1 | 3000 | 8000 |
| PRO-1 | mat-2 | | 0 | 1 | 2000 | 8000 |
| PRO-1 | mat-3 | D | 1 | 1 | 500 | 8000 |
| PRO-1 | mat-4 | D | 2 | 1 | 20 | 8000 |
| PRO-2 | mat-5 | | 0 | 2 | 300 | 100 |
| PRO-2 | mat-6 | | 0 | 2 | 300 | 100 |
| PRO-3 | mat-6 | | 0 | 1 | 300 | 20 |
| PRO-3 | mat-7 | | 0 | 3 | 500 | 20 |

Taking a first item in Table 3 as an example, a product PRO-1 needs to consume material mat-1, and mat-1 has no alternative material (an alternative group is marked as empty), one PRO-1 consumes one mat-1 (unit consumption is 1), inventory of mat-1 is 3000, and volume of demand of product PRO-1 is 8000.

It may be seen from Table 3 that in the product PRO-1, material mat-3 and material mat-4 are of alternative material relation (mat-3 and mat-4 have a same alternative group mark D). That is, the product PRO-1 has two formulas, formula 1: {mat-1, mat-2, mat-3} and formula 2: {mat-1, mat-2, mat-4}. In product PRO-2 and product PRO-3, there is a common material mat-6.

As shown in Table 3, for the product PRO-1, an existing demand is 8000. Due to insufficient material inventory, a quantity of complete sets may be 500 pieces by using the formula 1, because the material mat-3 may only meet a product demand of 500 pieces. A quantity of complete sets may be 20 pieces by using the formula 2, because the material mat-4 may only meet a product demand of 20 pieces. For the product PRO-2 and the product PRO-3, demands may be met. That is, a quantity of complete sets of products PRO-2 is 100 (for material mat-5 and material mat-6, an inventory is 300 and unit consumption is 2, and 100 products PRO-2 require 200 pieces of materials mat-5 and 200 pieces of materials mat-6), and a quantity of complete sets of products PRO-3 is 20 (an inventory of material mat-6 remains 100 pieces, there are 500 pieces of materials mat-7, 20 products PRO-3 require 20 pieces of materials mat-6, and 20*3=60 pieces of materials mat-7, all of which may be satisfied).

The data shown in Table 3 is only an example, and an amount of actual data may be much larger than that shown in Table 3.

A complete set algorithm service focuses on a quantity of products that may be produced in complete sets, and a gap quantity between the products and a demand. For materials with a complex alternative relationship and products, a detailed output value of products and material consumption under different material combinations and configurations may be output. When materials are shared and substitution is complex, a volume of detailed results obtained by calculation increase a lot.

Therefore, in the embodiment of the present disclosure, a calculation result of the complete set algorithm service is classified into summary result data and detailed result data. Among them, the summary result data only records a quantity of complete sets of products and a quantity of product gaps, which are critical conclusion data. The detailed result data includes a possible formula of each product under different combinations and configurations, and detailed usage of supporting materials, which may be used as auxiliary reference data for the caller 20.

Table 4 is a summary result data table provided in an exemplary embodiment. As shown in Table 4, the summary result data may include at least one of following: a quantity of complete sets of products, a gap quantity between a demand quantity of the products and the quantity of complete sets. That is, the gap quantity of products=the demand quantity of products minus the quantity of complete sets of products.

For example, a quantity of complete sets of products PRO-1 is 520, and a gap quantity is 8000−520=7480; a quantity of complete sets of products PRO-2 is 100, and a gap quantity is 0; a quantity of complete sets of products PRO-3 is 20, and a gap quantity is 0. It may be seen that an amount of the summary result data is relatively small, a product model has only one piece of data, and a data amount of this piece of data is also small, which occupies less transmission resources and transmission time, and may be transmitted to the caller 20 faster, which is convenient for the caller 20 to know summary information in time and has better real-time performance.

TABLE 4
Summary result data table

| Product | Complete set | Gap |
|---|---|---|
| number | quantity | quantity |
| PRO-1 | 520 | 7480 |
| PRO-2 | 100 | 0 |
| PRO-3 | 20 | 0 |

Table 5 is a detailed result data table provided in an exemplary embodiment. The detailed result data may include a possible material formula of a product, i.e., usage information of a material that may be used for the product. As shown in Table 5, the detailed result data may include a product number, a virtual product number, a material number, unit consumption, and material usage. Among them, the virtual product number may be used for distinguishing products using alternative materials, and when a product has no alternative material, the virtual product number may be consistent with the product number. It may be seen that, one product has a plurality of pieces of detailed result data, which are more than summary result data (only one piece) of one product, and a data volume of one piece of detailed result data is greater than a data volume of one piece of summary result data. Therefore, the data volume of the detailed result data is much larger than the data volume of the summary result data, which takes up more resources and takes longer for transmission. Transmitting the summary result data may achieve better real-time performance and is convenient for the caller 20 to know the summary information in advance.

TABLE 5
Detailed result data table

| | Virtual | | | |
|---|---|---|---|---|
| Product | product | Material | Unit | Material |
| number | number | number | consumption | usage |
| PRO-1 | PRO-1-1 | mat-1 | 1 | 500 |
| PRO-1 | PRO-1-1 | mat-2 | 1 | 500 |
| PRO-1 | PRO-1-1 | mat-3 | 1 | 500 |
| PRO-1 | PRO-1-2 | mat-1 | 1 | 20 |
| PRO-1 | PRO-1-2 | mat-2 | 1 | 20 |
| PRO-1 | PRO-1-2 | mat-4 | 1 | 20 |
| PRO-2 | PRO-2 | mat-5 | 2 | 200 |
| PRO-2 | PRO-2 | mat-6 | 2 | 200 |
| PRO-3 | PRO-3 | mat-6 | 1 | 20 |
| PRO-3 | PRO-3 | mat-7 | 3 | 60 |

The summary result data and the detailed result data shown in Tables 4 and 5 are taken as an example only. In a practical application, data volumes may be much larger than data volumes shown in Tables 4 and 5.

In an exemplary embodiment, the algorithm service 23 may process the first message using a plurality of processes, so that a processing efficiency is improved. Data volumes of different factories, different types of products and material data are quite different, which makes operating time ranging from a few seconds to dozens of minutes when calculating different batches of data. For this case, when a single thread is used for processing a message, and when there are short-term multi-batch data requests, there will be a large number of first messages waiting to be processed in the first message queue, so that processing time of the first message will be delayed. In the embodiment, a multi-process processing method may be used. When a plurality of first messages arrive at the first message queue 321, the algorithm service 23 initiates a plurality of processes to concurrently process the plurality of first messages, so as to avoid the accumulation of the first messages and delay of calculation response caused by a single first message occupying a Central Processing Unit (CPU) for calculation for a long time, and improve a processing efficiency.

A thread is an execution flow in a program, is a minimum processing unit for program execution, and is a minimum unit of a Central Processing Unit (CPU) scheduling. A process may include a plurality of threads. A single-core CPU supports one process, while a multi-core CPU may support multiple processes. In an exemplary implementation, a plurality of processes may be implemented by means of a process pool. The process pool includes a plurality of processes, which may concurrently take out tasks from a task queue storing tasks to be processed and execute the tasks, thus improving a processing efficiency. For example, a task is to take out a first message for preset processing.

When storing the summary result data and the detailed result data, they may be distinguished by file names. For example, a file name of the summary result data may include res_simple information, and a file name of the detailed result data may include res_detail information. However, embodiments of the present disclosure are not limited thereto, and the summary result data and the detailed result data may be distinguished by other means, such as storing the summary result data and the detailed result data in different preset storage spaces.

In an exemplary embodiment, the algorithm service 23 records execution to a log file to store it locally during processing. For example, it may record error information, which is convenient for quick positioning and problem solving when a problem occurs. The algorithm service 23 may generate a log file from summary result data of a batch of data, and generate a log file from detailed result data of the batch of data.

In the act 404, the algorithm service 23 stores the summary result data as a summary result data file, stores the detailed result data as a detailed result data file, sends a second message including a storage path of the summary result data file to a second message queue 322, and sends a third message including a storage path of the detailed result data file to a third message queue 323; wherein the algorithmic service 23 and the message middleware 22 may provide respective interfaces for the second message queue 322 and the third message queue 323 to transmit the second message and the third message, respectively.

In an exemplary embodiment, the second and third messages may include following fields: a message exchanger name field (exchange, this field carries a message exchanger name, and a message is sent to a message exchanger indicated by this field), a routing key field (routing_key, this field carries a routing rule, i.e. indicating to route to which message queue through the message exchanger, and the message exchanger delivers the message to a corresponding message queue according to the routing key), a data identifier field (package_id, this field is consistent with the field package_id of the aforementioned Table 2, identifying a locally received batch of data, that is, result data is result data of a batch of data indicated by the package_id), an algorithm execution result indication field (code, this field is used for indicating whether preset processing of the algorithm service 23 is executed successfully, for example, if execution is successful, code is set to 0, and if the execution fails, code may be set to 1, which is an example only, and code may be set to another value, or indicated by other means); an information prompt field (msg, which may be an empty string when preset processing is successfully executed (but not limited thereto, it may be other predefined information), and carries an error message prompt when the preset processing fails to execute); and a storage path field (respath, a storage path that carries result data). As shown in Table 6. Among them, a routing key field of the second message indicates delivery of the second message to the second message queue 322, and a storage path field of the second message carries the storage path of the summary result data file. A routing key field of the third message indicates delivery of the third message to the third message queue 323, and a storage path field of the third message carries the storage path of the detailed result data file. The fields shown in Table 6 are examples only, and fields may be increased or decreased as needed.

TABLE 6
Information content conveyed in the message

| exchange | Message exchanger name |
|---|---|
| routing_key | Routing key |
| package_id | Unique identifier of a batch of |
| | data, consistent with the field |
| | package_id in Table 2 |
| code | 0/1, code-0 when execution |
| | succeeds, code = 1 when execution |
| | fails |
| msg | The msg may be an empty |
| | string when execution succeeds, |
| | and content of the msg may be |
| | an error message prompt when |
| | execution fails |
| respath | Storage path |

In the act 405, the interface application service 21 monitors the second message queue 322 and the third message queue 323, acquires a second message from the second message queue 322 after monitoring the second message exists in the second message queue 322, acquires summary result data according to the storage path of the summary result data file in the second message, splits the summary result data into data packages according to a preset size, and sends the data packages to the caller 20; and acquiring a third message from the third message queue 323 after monitoring the third message exists in the third message queue 323, acquires detailed result data according to the storage path of the detailed result data file in the third message, splits the detailed result data into data packages according to a preset size, and sends the data packages to the caller 20.

In an exemplary embodiment, when the interface application service 21 sends a data package to the caller 20, the data package may carry data type indication information indicating that the data package is summary result data or detailed result data.

In an exemplary embodiment, when the interface application service 21 sends the data package to the caller 20, the data package may carry a batch number of a batch of data corresponding to the data package (the data package is result data of the batch of data), a total package quantity (when the data package is the summary result data, the total package quantity is a total package quantity of the summary result data; when the data package is the detailed result data, the total package quantity is a total package quantity of the detailed result data), a current data package number, and the data type indication information (indicating that the data package is the summary result data or the detailed result data).

In an exemplary embodiment, the preset size may be determined according to service and data transmission requirements.

In an exemplary embodiment, if the preset size is, for example, 1000 pieces (for example only, it may be another value), 1000 pieces of data as a package may be split into data packages, a total quantity of data packages transmitted is a total quantity of data pieces/1000, and a quantity of data pieces of a last data package is a quantity of data packages actually remained.

In an exemplary embodiment, one row in Tables 4 and 5 may be taken as one piece of data, which is only an example here, and one piece of data may include a plurality of rows.

In an exemplary embodiment, a data format of the data package includes, but is not limited to, json.

In an exemplary embodiment, similar to a process of received data processing, data recording may also be performed on sending processing of the summary result data and the detailed result data through a database (including, but not limited to, a mysql database). Two data tables, _result_package_item and _result_package, may be created. The table _result_package is used for storing related information of result data of a batch of data, and the _table _result package_item is used for storing detail information of data packages of result data in a batch, as shown in Table 7.

TABLE 7
Record table of sending information of result data

| Data table | Field name | Notes |
|---|---|---|
| _result_package | result_id | Self-incremented id, whenever result data |
| | | of one batch of data is sent, a count |
| | | is increased (all result data of one batch of |
| | | data correspond to one time) |
| | package_id | Corresponding to the field |
| | | package_id in _api_package |
| | total_split_package | Total package quantity |
| | send_start_at | Start time of sending the result data |
| | send_end_at | End time of sending the result data |
| | result_data | Storage path of a result data file |
| | queue | Result queue name (distinguishing |
| | | a summary result from a detailed result) |
| | code | Whether an algorithm is executed |
| | | successfully, code = 0 when it |
| | | succeeds and code = 1 when it fails |
| | msg | Algorithm attached message, the msg is |
| | | an empty string when the algorithm is |
| | | executed successfully, and the msg is an |
| | | error message prompt when it fails |
| | . . . | Other data information |
| _result_package_item | result_item_id | Self-incremented id |
| | result_id | Foreign key, corresponding to the |
| | | result_id field in_result_packag |
| | package_id | Corresponding to the package_id |
| | | field in _api_packag |
| | current_package | Current data package number |
| | result_data | Storage path of data of a data |
| | | package |
| | created_at | Time to start sending a data |
| | | package |
| | . . . | Other data information |

When a first data package of summary result data corresponding to a batch of data starts to be sent to the caller, it is determined whether package_id of the batch of data, to which the data package belongs, exists in_result_package, and a piece of record is created in the table _result_package when package_id does not exist or if the package_id exists but the field queue indicates detailed result data. In this piece of record, a value of the field result_id is increased by one count, a value of the field package_id is package_id of the current batch of data, a total package quantity in the field total_split_package is a total package quantity of the summary result data, the field send_start_at records time when the summary result data starts to be sent, the field result_data records a storage path of a summary result data file, the field queue records a name of a message queue where the summary result data is located (a second message queue), or it may be set as preset indication information indicating it is currently the summary result data. At this time, the field code may be 0 and the field msg may be an empty string, and information on the field code and the field msg may be acquired from the second message.

And a piece of record is created in the table result package_item to record detailed information of the data package. In the record, the _result_item_id is increased by one count, the field result_id is consistent with the field result_id in the table _result_package, the field package_id records that the current data package is result data of that batch of data (i.e., the current data package is result data of a batch of data indicated by passage_id), the field current_package records a current data package number, the field result_data records a storage path of data of the current data package, and the field created_at records time when the current data package starts to be sent.

A second counter cnt2 is used for counting data packages of the summary result data. When a first data package of the summary result data is sent, a count value of the second counter cnt2 is equal to 1. When subsequent data packages of the summary result data continue to be sent, a new record is added to the table _result_package_item to record information of newly sent data packages. The second counter cnt2 performs an accumulation operation cnt2+=1. When the count value of the second counter cnt2 is equal to the total package quantity of the summary result data to be sent, all the summary result data of the batch of data are successfully sent, and end time of sending the summary result data is recorded in the field send_end_at in a record corresponding to the summary result data in the table _result_package, and the second counter cnt2 is reset.

When a first data package of the detailed result data corresponding to the batch of data starts to be sent to the caller, it is determined whether package_id of the batch of data, to which the data package belongs, exists in_result_package, and a piece of record is created in the table _result_package when package_id does not exist or if the data package exists but the field queue indicates the summary result data. In this record, when the package_id of the batch of data corresponding to the detailed result data already exists in the table _result_package (a relevant record has been established when the summary result data is sent), the result_id field remains unchanged (consistent with the result_id in a record created when the summary result data is sent, that is, when result data of a batch of data is sent, the result_id is only increased once), a value of the package_id field is the package_id of the batch of data corresponding to the current detailed result data, a total package quantity in the total_split_package field is a total package quantity of the detailed result data, the send_start_at field records time when the detailed result data starts to be sent, the result_data field records a storage path of a detailed result data file, a name of a message queue where the detailed result data is located is recorded in the queue field (a third message queue), or it may be set as preset indication information indicating current data is the detailed result data; at this time, the code field may be 0 and the msg field may be an empty string; information of the code field and the msg field may be acquired from the third message; and one piece of detail information on the data package is created in the table _result_package_item, which is similar to a record when sending the summary result data, and will not be repeated here.

A third counter cnt3 is used for counting data packages of the detailed result data. When a first data package of the detailed result data is sent, a count value of the third counter cnt3 is equal to 1. When subsequent data packages of the detailed result data continue to be sent, a new record is added in the table _result_package_item to record information of newly sent data packages. The third counter performs an accumulation operation cnt3+=1. When the count value of the third counter cnt3 is equal to a total package quantity of the detailed result data to be sent, all the detailed result data of the batch of data are successfully sent, and end time of sending the detailed result data is recorded in the field send_end_at in a record corresponding to the detailed result data in the table _result_package, and the third counter cnt3 is reset.

The field result_item_id is increased by one count whenever a data package is sent (for example, it is incremented by 1), and types of data packages may not be distinguished. That is, whenever a data package of the summary result data is sent, the result_item_id is increased by one count, and whenever a data package of the detailed result data is sent, the result_item_id is increased by one count.

The fields in Table 7 are examples only. In other exemplary embodiments, the fields may be increased or decreased. For example, only batch information of sent data packages may be recorded, and a quantity of data packages of a same batch may be counted.

In another exemplary embodiment, four data tables, _result_package_item_1, _result_package_1, _result_package_item_2, and _result_package_2, may be created. Among them, the table _result_package_1 is used for storing information related to summary result data of a batch of data, the table _result_package_item_1 is used for storing detail information of data packages of the summary result data in a batch, the table _result_package_2 is used for storing information related to detailed result data of the batch of data, and the table _result_package_item_2 is used for storing detail information of data packages of the detailed result data in the batch.

In an exemplary embodiment, a message acknowledgement mechanism may be adopted for sending a data package. When the data package is successfully sent and the caller 20 successfully receives the data package, acknowledgement information is returned to the interface application service 21. After receiving the acknowledgement information, the interface application service 21 continues to send a next data package. The interface application service 21 sends a retry request (carrying a data package) when sending fails, and the program is interrupted once the retry request exceeds a limit.

In an exemplary embodiment, a data processing method is provided, including: an interface application service 21 receives a data package sent by a caller 20, wherein the data package carries a batch number, a total package quantity, and a current data package number; after the interface application service 21 receives the data package, the batch number, the total package quantity, and the current data package number of the data package are recorded; when a quantity of received data packages with a same batch number is consistent with the total package quantity, the data packages with the same batch number are merged into a data file, and a first message is generated according to a storage path of the data file, wherein the first message carries the storage path of the data file, a message exchanger name, a routing key, and a data identifier; the interface application service 21 sends the first message to a message middleware, and a message exchanger indicated by the message exchanger name in the first message sends the first message to a first message queue 321 according to the routing key; after the algorithm service 23 monitors the first message in the first message queue 321, the first message in the first message queue 321 is acquired, data of the data file is acquired according to the storage path of the data file carried in the first message, preset processing is performed according to the data, summary result data and detailed result data are generated, the summary result data is stored as a summary result data file, the detailed result data is stored as a detailed result data file, and a second message and a third message are generated; the second message carries a storage path of the summary result data file, a message exchanger name, a routing key, and a data identifier; the third message carries a storage path of the summary result data file, a message exchanger name, a routing key, and a data identifier; the algorithm service 23 sends the second message to the message middleware, and a message exchanger indicated by the message exchanger name in the second message sends the second message to a second message queue 322 according to the routing key in the second message; and sends the third message to the message middleware, and a message exchanger indicated by the message exchanger name in the third message sends the third message to the third message queue 323 according to the routing key in the third message; after the interface application service 21 monitors the second message exists in the second message queue 322, the second message is acquired from the second message queue 322, summary result data is acquired according to the storage path of the summary result data file in the second message, the summary result data is split into data packages according to a preset size, and the data packages are sent to the caller 20; and the third message is acquired from the third message queue 323 after monitoring the third message exists in the third message queue 323, detailed result data is acquired according to the storage path of the detailed result data file in the third message, the detailed result data is split into data packages according to a preset size, and the data packages are sent to the caller 20.

In an exemplary embodiment, there may be a plurality of algorithm services, at this time, a plurality of first message queues and a plurality of result message queues may be provided. For example, two first message queues are included and are referred to as a first input queue and a second input queue, respectively, and the plurality of result message queues are a second message queue, a third message queue, a fourth message queue, and a fifth message queue, respectively. Taking a case that there are two algorithm services, a first algorithm service and a second algorithm service, and each algorithm service generates two kinds of processing results as an example, wherein: when the first algorithm service is called, the interface application service sends a first message to the message middleware, and the message middleware sends the first message to a first input queue; the first algorithm service monitors the first input queue, acquires data according to the first message when the first message in the first input queue is monitored, performs first algorithm processing, generates two processing results (a first processing result and a second processing result), generates a second message carrying a storage address of the first processing result, sends the second message to the message middleware, and the message middleware sends the second message to a second message queue; generates a third message carrying a storage address of the second processing result, sends the third message to the message middleware, and the message middleware sends the third message to a third message queue; the interface application service monitors the second message queue, acquires the first processing result according to the second message when the second message existing in the second message queue is monitored, and sends the first processing result to the caller; the interface application service monitors the third message queue, acquires the second processing result according to the third message when the third message existing in the third message queue is monitored, and sends the second processing result to the caller; when the second algorithm service is called, the interface application service sends a first message to the message middleware, and the message middleware sends the first message to a second input queue; the second algorithm service monitors the second input queue, acquires data according to the first message when the first message in the second input queue is monitored, performs second algorithm processing, generates two processing results (a third processing result and a fourth processing result), generates a second message carrying a storage address of the third processing result, sends the second message to the message middleware, and the message middleware sends the second message to a fourth message queue; generates a third message carrying a storage address of the fourth processing result, sends the third message to the message middleware, and the message middleware sends the third message to a fifth message queue; the interface application service monitors the fourth message queue, acquires the third processing result according to the second message when the second message existing in the fourth message queue is monitored, and sends the second processing result to the caller; the interface application service monitors the fifth message queue, acquires the fourth processing result according to the third message when the third message existing in the fifth message queue is monitored, and sends the fourth processing result to the caller.

In an exemplary embodiment, different algorithm services may be switched according to user instructions or system configurations.

The above processing is for example only, and in another exemplary embodiment, when there are a plurality of algorithm services, a first message queue and a plurality of result message queues may be provided, and the plurality of algorithm services share the plurality of result message queues. The interface application service sends a first message to the message middleware, and the message middleware sends the first message to a first message queue; all the plurality of algorithm services monitor the first message queue, acquires data according to the first message when a called algorithm service monitors the first message existing in the first message queue, performs first algorithm processing, generates a plurality of processing results, e.g., a first processing result and a second processing result, generates a second message carrying a storage address of the first processing result, sends the second message to the message middleware, and the message middleware sends the second message to a second message queue; generates a third message carrying a storage address of the second processing result, sends the third message to the message middleware, and the message middleware sends the third message to a third message queue; the interface application service monitors the second message queue, acquires the first processing result according to the second message when the second message existing in the second message queue is monitored, and sends the first processing result to the caller; the interface application service monitors the third message queue, acquires the second processing result according to the third message when the third message existing in the third message queue is monitored, and sends the second processing result to the caller. Unused algorithm services may be called according to user instructions or system configurations.

A computer device is provided in an embodiment of the present disclosure, including a processor and a memory storing a computer program that may be run on the processor, wherein the processor implements acts of the data processing method of any one of the above-mentioned embodiments when executing the program.

A computer readable storage medium is provided in an embodiment of the present disclosure, in which program instructions are stored, and when the program instructions are executed, the data processing method of any one of the above-mentioned embodiments is implemented.

Those of ordinary skills in the art may understand that all or some of acts in the methods disclosed above, systems, functional modules or units in apparatuses may be implemented as software, firmware, hardware, and an appropriate combination thereof. In a hardware implementation, division of the function modules/units mentioned in the above description is not always corresponding to division of physical components. For example, a physical component may have multiple functions, or a function or an act may be executed by several physical components in cooperation. Some components or all components may be implemented as software executed by a processor such as a digital signal processor or a microprocessor, or implemented as hardware, or implemented as an integrated circuit such as a specific integrated circuit. Such software may be distributed on a computer-readable medium, and the computer-readable medium may include a computer storage medium (or a non-transitory medium) and a communication medium (or a transitory medium). As known to those of ordinary skills in the art, a term computer storage medium includes volatile or nonvolatile, and removable or irremovable media implemented in any method or technology for storing information (for example, a computer-readable instruction, a data structure, a program module, or other data). The computer storage medium includes, is but not limited to, a Random Access Memory (RAM), a Read-Only Memory (ROM), an Electrically Erasable Programmable ROM (EEPROM), a flash memory or other memory technologies, a Compact Disc Read-Only Memory (CD-ROM), a Digital Video Disk (DVD) or other optical discs, a cassette, a magnetic tape, a disk memory or other magnetic storage apparatuses, or any other medium configurable to store expected information and accessible by a computer. In addition, it is known to those of ordinary skill in the art that the communication medium usually includes a computer-readable instruction, a data structure, a program module, or other data in a modulated data signal of, such as, a carrier or another transmission mechanism, and may include any information delivery medium.

1. A data processing method, comprising:
receiving data from a caller, generating a first message according to the data, and sending the first message to a first message queue;
monitoring the first message queue, acquiring the data according to the first message in the first message queue after monitoring the first message existing in the first message queue, performing preset processing according to the data, generating at least one processing result, generating a result message according to the processing result and sending the result message to a result message queue corresponding to the processing result;
monitoring the result message queue, acquiring the processing result according to the result message of the result message queue after monitoring the result message existing in the result message queue, and sending the processing result to the caller.

2. The data processing method according to claim 1, wherein one processing result corresponds to one result message queue.

3. The data processing method according to claim 1, wherein the first message comprises a storage path of the data; the result message comprises a storage path of the processing result.

4. The data processing method according to claim 1, wherein the generating at least one processing result comprises: generating summary result data and detailed result data, wherein a data volume of the summary result data is smaller than a data volume of the detailed result data;
the result message queue comprises a second message queue and a third message queue;
the generating the result message according to the processing result and sending the result message to the result message queue corresponding to the processing result comprises:
generating a second message to the second message queue according to the summary result data, and generating a third message to the third message queue according to the detailed result data;
the monitoring the result message queue, acquiring the processing result according to the result message of the result message queue after monitoring the result message existing in the result message queue, and sending the processing result to the caller, comprises:
monitoring the second message queue, acquiring the summary result data according to the second message in the second message queue after monitoring the second message existing in the second message queue, and sending the summary result data to the caller; and
monitoring the third message queue, acquiring the detailed result data according to the third message in the third message queue after monitoring the third message existing in the third message queue, and sending the detailed result data to the caller.

5. The data processing method according to claim 4, wherein the data comprises product demand information and related material information;
the summary result data comprises at least one of following: a complete set quantity of products, a gap quantity between a required quantity of the products and the complete set quantity; and the detailed result data comprises a possible material formula of the products.

6. The data processing method according to claim 1, wherein the receiving the data from the caller comprises:
receiving, from the caller, data packages obtained by splitting;
after receiving the data packages of a same batch of data completely, merging the data packages of the batch of data to generate a data file, wherein one batch of data is data on which preset processing is performed once;
the generating the first message according to the data and sending the first message to the first message queue, comprises: sending a storage path of a data file of a current batch of data to the first message queue.

7. The data processing method according to claim 6, wherein the receiving the data packages from the caller and receiving the data packages of the same batch of data completely, comprises:
acquiring batch information and a total package quantity carried in the data packages, counting received data packages with same and non-repeated batch information, and determining that the data packages of the same batch of data have been received when a count value reaches the total package quantity.

8. The data processing method according to claim 6, wherein the sending the processing result to the caller, comprises:
splitting a same processing result of a same batch of data into data packages according to a preset size, and sending the data packages obtained by splitting to the caller.

9. The data processing method according to claim 8, wherein the processing result comprises summary result data and detailed result data, and the method further comprises:
when sending the data packages obtained by splitting to the caller, carrying data type indication information to indicate that the data packages are the summary result data or the detailed result data.

10. The data processing method according to claim 1, wherein the acquiring the data according to the first message in the first message queue, performing preset processing according to the data, and generating at least one processing result, comprises: acquiring the data from a plurality of first messages in the first message queue using a plurality of processes, respectively, performing preset processing according to the data, and generating at least one processing result.

11. The data processing method according to claim 1, wherein the receiving data from the caller, generating the first message according to the data, and sending the first message to the first message queue, comprises:
receiving, by an interface application service, the data from the caller, generating the first message according to the data and sending the first message to a message middleware; sending, by the message middleware, the first message to the first message queue;
the monitoring the first message queue, acquiring the data according to the first message in the first message queue after monitoring the first message existing in the first message queue, performing preset processing according to the data, generating at least one processing result, generating the result message according to the processing result and sending the result message to the result message queue corresponding to the processing result, comprises:
monitoring, by an algorithm service, the first message queue, acquiring the data according to the first message in the first message queue after monitoring the first message existing in the first message queue, performing preset processing according to the data, generating at least one processing result, generating the result message according to the processing result and sending the result message to the message middleware; sending, by the message middleware, the result message to the result message queue corresponding to the processing result;
the monitoring the result message queue, acquiring the processing result according to the result message of the result message queue after monitoring the result message existing in the result message queue, and sending the processing result to the caller, comprises:
monitoring, by the interface application service, the result message queue, acquiring the processing result according to the result message of the result message queue after monitoring the result message existing in the result message queue, and sending the processing result to the caller.

12. A computer device, comprising a processor and a memory storing a computer program runnable on the processor, wherein when the processor executes the program, acts of a data processing method according to claim 1 are implemented.

13. A non-transitory computer storage medium, in which program instructions are stored, wherein when the program instructions are executed, a data processing method according to claim 1 is implemented.

14. A data processing apparatus, comprising: an interface application service, a message middleware, and an algorithm service, wherein
the interface application service is configured to receive data from a caller, generate a first message according to the data and send the first message to the message middleware, monitor a result message queue, acquire a processing result according to a result message of the result message queue after monitoring the result message existing in the result message queue, and send the processing result to the caller;
the algorithm service is configured to monitor the first message queue, acquire the data according to the first message in the first message queue after monitoring the first message existing in the first message queue, perform preset processing according to the data, generate at least one processing result, generate a result message according to the processing result and send the result message to the message middleware; and
the message middleware is configured to receive the first message and send the first message to the first message queue, receive the result message, and send the result message to a corresponding result message queue.

15. The data processing method according to claim 2, wherein the acquiring the data according to the first message in the first message queue, performing preset processing according to the data, and generating at least one processing result, comprises: acquiring the data from a plurality of first messages in the first message queue using a plurality of processes, respectively, performing preset processing according to the data, and generating at least one processing result.

16. The data processing method according to claim 3, wherein the acquiring the data according to the first message in the first message queue, performing preset processing according to the data, and generating at least one processing result, comprises: acquiring the data from a plurality of first messages in the first message queue using a plurality of processes, respectively, performing preset processing according to the data, and generating at least one processing result.

17. The data processing method according to claim 4, wherein the acquiring the data according to the first message in the first message queue, performing preset processing according to the data, and generating at least one processing result, comprises: acquiring the data from a plurality of first messages in the first message queue using a plurality of processes, respectively, performing preset processing according to the data, and generating at least one processing result.

18. The data processing method according to claim 2, wherein the receiving data from the caller, generating the first message according to the data, and sending the first message to the first message queue, comprises:
receiving, by an interface application service, the data from the caller, generating the first message according to the data and sending the first message to a message middleware; sending, by the message middleware, the first message to the first message queue;
the monitoring the first message queue, acquiring the data according to the first message in the first message queue after monitoring the first message existing in the first message queue, performing preset processing according to the data, generating at least one processing result, generating the result message according to the processing result and sending the result message to the result message queue corresponding to the processing result, comprises:
monitoring, by an algorithm service, the first message queue, acquiring the data according to the first message in the first message queue after monitoring the first message existing in the first message queue, performing preset processing according to the data, generating at least one processing result, generating the result message according to the processing result and sending the result message to the message middleware; sending, by the message middleware, the result message to the result message queue corresponding to the processing result;
the monitoring the result message queue, acquiring the processing result according to the result message of the result message queue after monitoring the result message existing in the result message queue, and sending the processing result to the caller, comprises:
monitoring, by the interface application service, the result message queue, acquiring the processing result according to the result message of the result message queue after monitoring the result message existing in the result message queue, and sending the processing result to the caller.

19. The data processing method according to claim 3, wherein the receiving data from the caller, generating the first message according to the data, and sending the first message to the first message queue, comprises:
receiving, by an interface application service, the data from the caller, generating the first message according to the data and sending the first message to a message middleware; sending, by the message middleware, the first message to the first message queue;
the monitoring the first message queue, acquiring the data according to the first message in the first message queue after monitoring the first message existing in the first message queue, performing preset processing according to the data, generating at least one processing result, generating the result message according to the processing result and sending the result message to the result message queue corresponding to the processing result, comprises:
monitoring, by an algorithm service, the first message queue, acquiring the data according to the first message in the first message queue after monitoring the first message existing in the first message queue, performing preset processing according to the data, generating at least one processing result, generating the result message according to the processing result and sending the result message to the message middleware; sending, by the message middleware, the result message to the result message queue corresponding to the processing result;
the monitoring the result message queue, acquiring the processing result according to the result message of the result message queue after monitoring the result message existing in the result message queue, and sending the processing result to the caller, comprises:
monitoring, by the interface application service, the result message queue, acquiring the processing result according to the result message of the result message queue after monitoring the result message existing in the result message queue, and sending the processing result to the caller.

20. The data processing method according to claim 4, wherein the receiving data from the caller, generating the first message according to the data, and sending the first message to the first message queue, comprises:
receiving, by an interface application service, the data from the caller, generating the first message according to the data and sending the first message to a message middleware; sending, by the message middleware, the first message to the first message queue;
the monitoring the first message queue, acquiring the data according to the first message in the first message queue after monitoring the first message existing in the first message queue, performing preset processing according to the data, generating at least one processing result, generating the result message according to the processing result and sending the result message to the result message queue corresponding to the processing result, comprises:
monitoring, by an algorithm service, the first message queue, acquiring the data according to the first message in the first message queue after monitoring the first message existing in the first message queue, performing preset processing according to the data, generating at least one processing result, generating the result message according to the processing result and sending the result message to the message middleware; sending, by the message middleware, the result message to the result message queue corresponding to the processing result;
the monitoring the result message queue, acquiring the processing result according to the result message of the result message queue after monitoring the result message existing in the result message queue, and sending the processing result to the caller, comprises:
monitoring, by the interface application service, the result message queue, acquiring the processing result according to the result message of the result message queue after monitoring the result message existing in the result message queue, and sending the processing result to the caller.
